(19) United States
(12) Patent Application Publication
(10) Pub. No.: US 2005/0281917 A1
(43) Pub. Date: Dec. 22, 2005

(54) Treatment of silage with lactobacillus diolivorans

(76) Inventors: Robert C. Charley, Niagara-on-the-Lake (CA); Limin Kung JR., Newark, DE (US)

Correspondence Address: NUTTER MCCLENNEN & FISH LLP, WORLD TRADE CENTER WEST, 155 SEAPORT BOULEVARD, BOSTON, MA, 02210-2604, US

(21) Appl. No.: 11/155,019

(22) Filed: Jun. 16, 2005

Related U.S. Application Data
(60) Provisional application No. 60/580,066, filed on Jun. 16, 2004.

(51) Int. Cl. A23K 1/00

(52) U.S. Cl. 426/53

(57) ABSTRACT

Disclosed herein are various Lactobacillus diolivorans compositions and methods used for the treatment and prevention of the spoilage of silage, as well as to provide silage that is stable upon exposure to air. In an exemplary embodiment, a composition is provided that includes a concentration of Lactobacillus diolivorans that can be effective to delay or reduce heating by delaying or eliminating the growth of yeasts and molds in the silage.

### RELATED APPLICATIONS

The present application claims the benefit of the filing date of U.S. Provisional Patent Application Ser. No. 60/580,066, filed Jun. 16, 2004, which is herein incorporated by reference.

### FIELD OF THE INVENTION

The present invention relates to methods and compositions that include Lactobacillus diolivorans for use in treatment and prevention of spoilage in silage.

### BACKGROUND OF THE INVENTION

The production of silage and the associated crop husbandry have over recent years developed to an extent that a number of different processes can be defined. These processes include: (i) the ensiling of young grass with particularly low dry matter, e.g. less than 25%; (ii) the ensiling of higher dry matter, more mature grasses or the ensiling of high dry matter but young grass achieved by wilting; and (iii) the ensiling of whole maize including stover and cob, usually at a dry matter concentration of about 35%, and whole crop cereals, e.g., wheat, at 45-50% dry matter.

While these processes generally produce a good yield, they are not without their problems. For example, spoilage is a common problem during the production of silage, and is particularly acute in processes (ii) and (iii), as well as other processes that contain a substantial content of dry matter, e.g., a dry matter content over 30%.

Fermative treatment with lactic acid bacteria is a common procedure to prevent spoilage and preserve the high nutritional value of the silage. This procedure is based on lactic acid fermentation of water-soluble carbohydrates by lactic acid bacteria, which are common members of the natural epiphytic microflora of freshly harvested crops. However, even when satisfactory preservation under anoxic conditions has been attained, exposure to air, particularly during feed-out, may result in aerobic growth of yeasts and fungi at the expense of lactic acid. This process is referred to as aerobic spoilage.

While it is not well understood, aerobic spoilage results in dramatic losses in the nutritional value of spoilage. Generally, the process of aerobic spoilage has been divided into three phases. In the initial phase, yeasts and sometimes acetic acid bacteria start to respire the preserving organic acids, raising the silage pH and temperature. After this initial rise in pH, there is a secondary phase in which the activity of bacilli is apparent, and is associated with increasing temperature. A further phase includes activity of various microorganisms including fungi.

Biological additives such as bacterial inoculants have been used widely to improve the silage process, primarily to increase the extent and rate of lactic acid production, and guard against aerobic spoilage. One current treatment, described in U.S. Pat. No. 6,326,037 to Mann et al., which is herein incorporated by reference, is based at least in part on identifying the aerobic spoilage process as being closely related to heating in the clamp on exposure to the ingress of air. Subsequent examination of such silages indicate a secondary fermentation (the primary fermentation being the ensiling process) where there is a high concentration of thermophilic Gram-positive bacteria, including bacilli, yeasts, and molds. It naturally follows that in order to prevent spoilage, the three main categories of organisms that need to be killed or suppressed are spore-forming bacteria, yeasts, and fungi, and to eliminate only one category may lead to the proliferation of the remaining categories, so that spoilage is not prevented.

Accordingly, Mann teaches spoilage prevention by using treatment organisms that, at least in the first instance, inhibit microorganisms that initiate aerobic spoilage, notably yeasts and, at the surface of silage, fungi. Moreover, such a treatment organism can also inhibit the development of other spoilage microorganisms, and be identified by screening. A suitable treatment organism for silage includes those of the species Lactobacillus buchneri, which was deposited at the National Collection of Industrial and Marine Bacteria on 13 Feb. 1996, and has accession number 40788.

A further organism has also been found in silage, as described in J. Krooneman et al., “Lactobacillus diolivorans sp. nov., a 1,2-propanediol-degrading bacterium isolated from aerobically stable maize silage,” International Journal of Systematic and Evolutionary Microbiology, Vol 52, pp. 639-646 (2002), which is herein incorporated by reference. Specifically, Krooneman noted that inoculation of maize silage with Lactobacillus buchneri (5×10(5) c.f.u. g(−1) of maize silage) prior to ensiling results in the formation of aerobically stable silage. After 9 months, lactic acid bacterium counts were approximately 10(10) c.f.u. g(−1) in the treated silages. An important subpopulation (5.9×10(7) c.f.u. g(−1)) proved able to degrade 1,2-propanediol, a fermentation product of L. buchneri, under anoxic conditions to 1-propanol and prop ionic acid. From this group of 1,2-propanediol-fermenting, facultatively anaerobic, heterofermentative lactobacilli, two rod-shaped isolates were purified and characterized. Comparative 16S rDNA sequence analysis revealed that the newly isolated bacteria have identical 16S rDNA sequences and belong phylogenetically to the L. buchneri group. DNA-DNA hybridizations, whole-cell protein fingerprinting and examination of phenotypic properties indicated that these two isolates represent a novel species, which was called Lactobacillus diolivorans sp. nov. The type strain of Lactobacillus diolivorans is LMG 19667(T) (=DSM 14421(T)).

While treatments using Lactobacillus buchneri reduce spoilage in silage, they do so to only a limited extent. Accordingly, the remains a need for an improved silage treatment.

### SUMMARY OF THE INVENTION

Disclosed herein are various exemplary methods and compositions for use in the treatment of silage, and in particular to treat and prevent spoilage thereof. In one aspect, a method for treating silage to prevent or reduce aerobic spoilage is disclosed which includes adding an inoculant composition to silage that has an amount of Lactobacillus diolivorans effective to prevent or reduce aerobic spoilage thereof. The silage can be closed for a period of at least 30 days subsequent to the addition of the inoculant, and during the extended time period the treated silage can be essentially thermostable, e.g., it maintains ambient temperatures. Moreover, the prevention or reduction of aerobic spoilage can occur without the formation of a secondary metabolite or a fatty acid.

One skilled in the art will appreciate that the silage inoculant can have a variety of compositions. In one embodiment, it can consist essentially of Lactobacillus diolivorans. Alternatively, it can include an amount of Lactobacillus diolivorans, Lactobacillus buchneri, and P. pentosaceus, or it can include an amount of Lactobacillus diolivorans, Lactobacillus buchneri, P. pentosaceus, and propanediol.

In another aspect, a silage inoculant is disclosed that has an amount of Lactobacillus diolivorans that is effective to prevent or reduce spoilage of the silage. As noted above, the silage inoculant can have a variety of compositions. In one embodiment, it can consist essentially of Lactobacillus diolivorans. Alternatively, it can include an amount of Lactobacillus diolivorans, Lactobacillus buchneri, and P. pentosaceus, or it can include an amount of Lactobacillus diolivorans, Lactobacillus buchneri, P. pentosaceus, and propanediol.

In a third aspect, an aerobically stable silage product is disclosed that includes a silage and Lactobacillus diolivorans. The aerobically stable silage product can be essentially thermostable, and able to maintain ambient temperatures for an extended time period. While the extended time period can vary, in an exemplary embodiment it is at least 30 days. Moreover, formation of the aerobically stable silage product can occur without the formation of a secondary metabolite or a fatty acid.

Similar to the above, the silage inoculant can have a variety of compositions. In one embodiment, it can consist essentially of Lactobacillus diolivorans. Alternatively, it can include an amount of Lactobacillus diolivorans, Lactobacillus buchneri, and P. pentosaceus, or it can include an amount of Lactobacillus diolivorans, Lactobacillus buchneri, P. pentosaceus, and propanediol.

### BRIEF DESCRIPTION OF THE DRAWINGS

FIG. 1 is a table showing the chemical (% DM) and microbial composition (fresh weight basis) of untreated corn silage (03Diol); and

FIG. 2 is a table showing the chemical (% DM) and microbial composition (fresh weight basis) of corn silage treated with various bacteria and propanediol after 64 days of ensiling (03Diol).

### DETAILED DESCRIPTION OF THE INVENTION

The present invention involves the use of various Lactobacillus diolivorans compositions in order to treat and prevent the spoilage of silage, as well as to provide silage that is stable upon exposure to air. In an exemplary embodiment, a composition is provided that includes a concentration of L. diolivorans that can be effective to delay or reduce heating by delaying or eliminating the growth of yeasts and molds in the silage.

While the exemplary results are based on corn silage, one skilled in the art will appreciate that the compositions and methods disclosed herein can be used to treat a variety of types of silage that are susceptible to aerobic spoilage. For example, the silage can preferably include at least 25% by weight dry matter, and can be rye or traditional grass, maize, Lucerne, wilted grass, wheat, barley, or other whole crop cereal. The silage can be in bales, or alternatively, any susceptible animal feed (e.g., for pigs, poultry, or ruminants) in a solid or liquid form. Moreover, the compositions and methods disclosed herein can be used to inhibit the growth of various spoilage organisms (e.g., bacteria, molds, and fungi), such as Listeria organisms, Bacillus spp., Guillermondella selenospora, Trichoderma longibrachiatum, Aspergillus niger, Monascus, Pennicillium roquefortii, Fusarium spp., and enteric bacteria such as Salmonella.

Following methods as discussed below, Applicants discovered chemical and microbial compositions having a concentration of L. diolivorans that are better able to treat and prevent aerobic spoilage in silage, and in particular corn silage.

In making this determination, Applicants examined the effects of the following combinations on corn silage:
1) nothing-control;
2) 0.5% (DM basis) of ½ propanediol (PD);
3) L. buchneri (400,000 cfu/g of forage) and P. pentosaceus (100,000 cfu/g of forage) combination (LBC);
4) L. diolivorans (strain # 19667) (1,000,000 cfu/g of forage) (LD);
5) PD+LBC;
6) LBC+LD;
7) PD+LD; and
8) PD+LD+LBC.

The LBC inoculant was a dry powder that was reconstituted in deionized water prior to use. The LD was grown up overnight in MRS broth, centrifuged to obtain a microbial pellet and reconstituted in ¼ strength Ringers buffer. The reconstituted culture was plated on MRS to determine cell numbers and used accordingly to achieve the desired application rate.

The silage was harvested at about ½ milk link at 32% DM, and packed (density of ˜14 lb of DM/cu ft) in 20-L pails in triplicate for each treatment. One skilled in the art will appreciate that the silage can be closed for a period of at least 30 days subsequent to the addition of the inoculant, and during the extended time period the treated silage can be essentially thermostable, e.g., it maintains ambient temperatures.

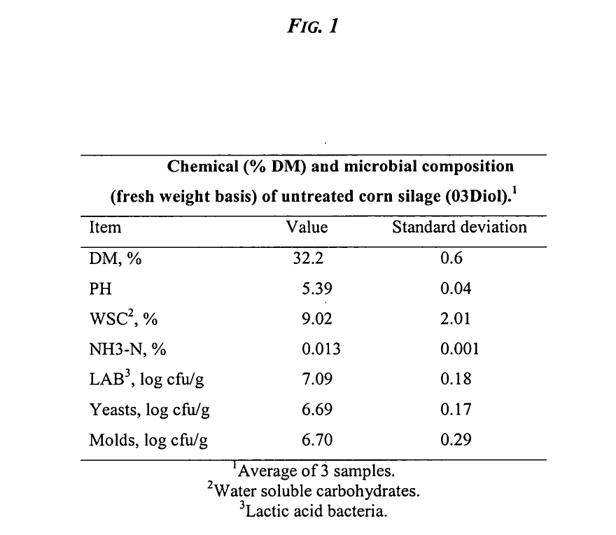

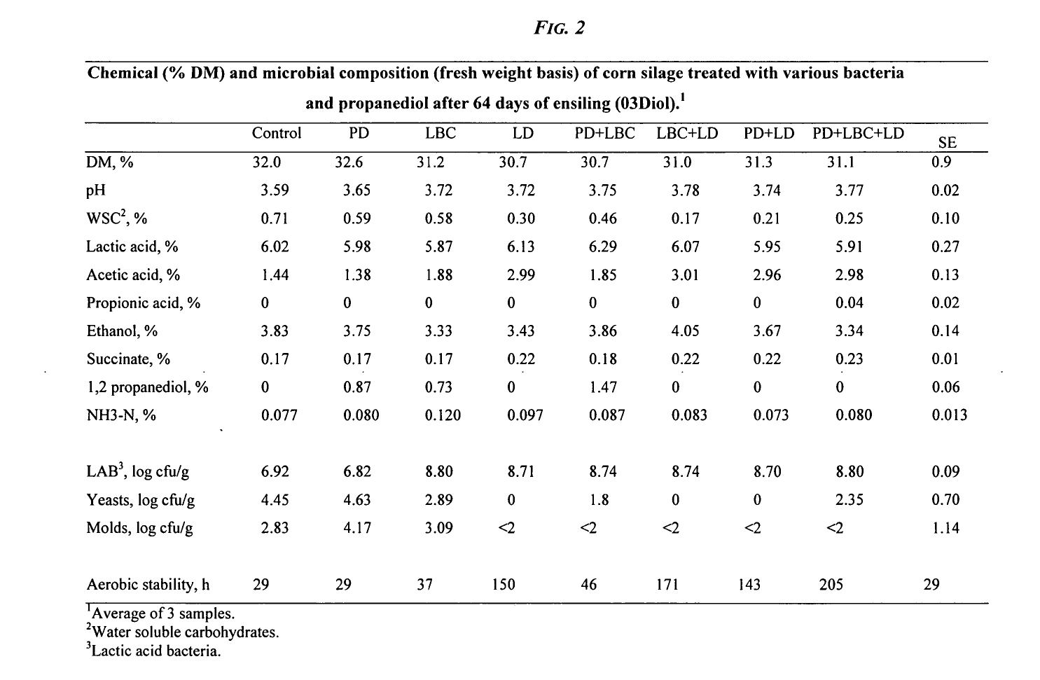

Following maintenance in the range of about 30 days to 75 days, and ensiling after about 64 days, analyses and aerobic stability were examined as is known in the art. These results are summarized in FIGS. 1 and 2. Specifically, all microbial data were transformed to log10 and is presented on a wet weight basis, and all chemical data were presented on a DM basis. Data was analyzed using the general linear models procedure of SAS (1998) for a completely randomized design. Differences among means were tested using Tukey's Test (Snedecor and Cochran, 1980), and an a level of P<0.05 was deemed significant.

As shown in FIG. 2, the chemical and microbial compositions of the silage resulting from treatment with each of the various composition was as follows:
1) Control=32.0% DM;
2) PD alone=32.6% DM;
3) LBC alone=31.2% DM;
4) LD alone=30.7% DM;
5) PD+LBC=30.7% DM;
6) LBC+LD=31.0% DM;
7) PD+LD=31.3% DM;
8) PD+LBC+LD=31.1% DM; and
9) SE=0.9% DM.

Moreover, treatments that contained a microbial inoculant, e.g., LD or LBC, all had higher numbers of lactic acid bacteria (e.g., greater than 8.7 log cfu/g) than did control silage or silage treated with PD alone (e.g., less than log 7 cfu/g), suggesting that inoculants dominated the fermentation process.

While not wishing to limit the invention to one mechanism of operation, Applicants believe that the improvement in aerobic stability of the silage was not due to the production of a secondary metabolite and fatty acids by the organisms, such as described in U.S. Pat. No. 6,326,037 to Mann. Compared to the control corn silage shown in (FIG. 1), addition of PD alone had no effects on the fermentation, microbial population, or aerobic stability of corn silage with the exception of a higher concentration of the chemical itself (about 0.87% vs. about 0) suggesting that it was not metabolized by any epiphytic organisms. The combination treatment of PD+LBC contained about 1.47% propanediol which is an expected finding based on what was observed in the separate treatments. Addition of LBC alone (about 1.88%) numerically but not statistically increased the concentration of acetic acid over the control silage (about 1.44%). However, it produced a concentration of 1,2 propanediol (about 0.73%) that was similar to what was added in the PD treatment. Treatment with LBC alone also numerically decreased the numbers of yeasts (about 2.89 log cfu/g) when compared to control silage (about 4.63 log cfu/g). These described changes caused by LBC are consistent with previous findings.

Addition of LD alone or in combination with any other treatment resulted in silages with the highest concentrations of acetic acid, between the range of about 2.5% to 3.5%, and more preferably between the range of about 2.96% to 3.01%. While unexpected, one skilled in the art will appreciate that this finding may be due to the high rate of application (about 1×106 cfu/g) of this heterolactic acid bacteria. Moreover, as would be expected because of this finding the high concentration of acetic acid, treatments with LD also had low numbers of yeasts and molds relative to control silage that were less than 2 log cfu/g, and more preferably between the range of about 0 log cfu/g to 2.35 log cfu/g.

The aerobic stability of corn silage was unaffected by PD (about 29 h), LBC (about 37 h), or PD+LBC (about 46 h) although it was numerically greater for treatments containing LBC when compared to control silage (about 29 h). In contrast, all treatments with LD were substantially more stable (greater than 143 h) than control silage.

Moreover, the addition of LBC alone, PD alone, or a combination of the two, resulted in the accumulation of propanediol suggesting that the corn silage did not contain epiphytic organisms capable of metabolizing this compound. In contrast, any silage treated with LD alone or in any combination was void of propanediol after 64 days of ensiling clearly showing that this organism can metabolize propanediol. However, increased levels of propionic acid were not found in these silages suggesting that LD converted propanediol to an intermediate form. As a result, all silages treated with LD were extremely stable when exposed to air most likely because of the high concentrations of acetic acid and low numbers of fungi in theses silages.

Thus, and contrary to the prior art which teaches that LD would be able to metabolize propanediol to propionic acid, further treatments that contained LD and PD had no detectable concentrations of propionic acid in the silages with the exception of a very low level found in PD+LBC+LD. Even more surprising was that none of these treatments contained detectable levels of propanediol. While this might be due the mechanism of operation, as discussed supra, a more probable explanation for this finding might be that LD may have taken propanediol to an intermediate metabolite but did not have sufficient time in the 64 days of ensiling to complete the conversion to propionic acid.

A person of ordinary skill in the art will appreciate further features and advantages of the invention based on the above-described embodiments. For example, specific features from any of the embodiments described above as well as in U.S. Pat. No. 6,326,037 to Mann may be incorporated into compositions or methods of the invention in a variety of combinations and subcombinations, as well as features referred to in the claims below which may be implemented by means described herein. Accordingly, the invention is not to be limited by what has been particularly shown and described, except as indicated by the appended claims or those ultimately provided. Any publications and references cited herein are expressly incorporated herein by reference in their entirety.

1. A method for treating silage to prevent or reduce aerobic spoilage, comprising:
adding to said silage an inoculant composition having an amount of Lactobacillus diolivorans that is effective to prevent or reduce said aerobic spoilage.

2. The method of claim 1, wherein the inoculant composition consists essentially of Lactobacillus diolivorans.

3. The method of claim 2, wherein the step of adding an inoculant composition to the silage further comprises adding about 1,000,000 cfu/g of forage of Lactobacillus diolivorans to the silage.

4. The method of claim 1, wherein the inoculant composition further comprises Lactobacillus buchneri and P. pentosaceus.

5. The method of claim 4, wherein the step of adding an inoculant composition to the silage further comprises adding about 1,000,000 cfu/g of forage of Lactobacillus diolivorans, about 400,000 cfu/g of forage of Lactobacillus buchneri to the silage, and about 100,000 cfu/g of forage of P. pentosaceus to said silage.

6. The method of claim 4, wherein the inoculant composition further comprises propanediol.

7. The method of claim 6, wherein the chemical and microbial composition of the silage is greater than about 30.7% DM.

8. The method of claim 1, further comprising maintaining the silage closed for a period of at least 30 days subsequent to the addition of the inoculant, wherein the treated silage is essentially thermostable maintaining ambient temperatures for an extended time period.

9. The method of claim 1, wherein said prevention or reduction of aerobic spoilage occurs without the formation of a secondary metabolite or a fatty acid.

10. A silage inoculant comprising:
an amount of Lactobacillus diolivorans that is effective to prevent or reduce spoilage of said silage.

11. The silage inoculant of claim 10, wherein the amount of Lactobacillus diolivorans is about 1,000,000 cfu/g of forage.

12. The silage inoculant of claim 10, wherein the inoculant further comprises Lactobacillus buchneri and P. pentosaceus.

13. The silage inoculant of claim 12, wherein the amount of Lactobacillus diolivorans is about 1,000,000 cfu/g of forage, the amount of Lactobacillus buchneri is about 400,000 cfu/g of forage, and the amount of P. pentosaceus is about 100,000 cfu/g of forage.

14. The silage inoculant of claim 12, wherein the inoculant further comprises propanediol.

15. An aerobically stable silage product comprising:
a silage; and
Lactobacillus diolivorans.

16. The product of claim 15, wherein the amount of Lactobacillus diolivorans is about 1,000,000 cfu/g of forage.

17. The product of claim 15, wherein the composition of lactic acid bacteria in the silage is about 8.71 log cfu/g.

18. The product of claim 15, further comprising Lactobacillus buchneri and P. pentosaceus.

19. The product of claim 18, wherein the amount of Lactobacillus buchneri is about 400,000 cfu/g of forage, and the amount of P. pentosaceus is about 100,000 cfu/g of forage.

20. The product of claim 18, wherein the composition of yeast and mold in the silage is in the range of about 0 log cfu/g to 2 log cfu/g.

21. The product of claim 18, further comprising propanediol.

22. The product of claim 21, wherein the aerobic stability of the silage is greater than about 143 h.

23. The product of claim 21, wherein the chemical and microbial composition of the silage is greater than about 30.7% DM.

24. The product of claim 15, wherein the aerobically stable silage product is essentially thermostable maintaining ambient temperatures for an extended time period, wherein the extended period of time is at least 30 days.

25. The product of claim 15, wherein the formation of the aerobically stable silage product occurs without the formation of a secondary metabolite or a fatty acid.
